(19) United States
(12) Patent Application Publication
(10) Pub. No.: US 2012/0192054 A1
(43) Pub. Date: Jul. 26, 2012

(54) COMPUTING DEVICE AND METHOD FOR CUTTING OUT SUMMARY DIAGRAM OF PATENT DOCUMENT

(75) Inventors: WEI-QING XIAO, Shenzhen City (CN); CHUNG-I LEE, Tu-Cheng (TW); CHIEN-FA YEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/339,177

(22) Filed: Dec. 28, 2011

(30) Foreign Application Priority Data
Jan. 21, 2011 (CN) 201110024376.2

(51) Int. Cl. G06F 17/00

(52) U.S. Cl. 715/227; 715/246

(57) ABSTRACT

A method for cutting out a summary diagram of a patent document reads a first page of a patent document and divides the first page into multiple blocks. The method selects the block which has a width value greater than a predetermined width value, and cut off blank areas of the selected block, to maintain a area that includes the summary diagram in the selected block. The method displays the area as the diagram in a search result of the patent document on a display device, and the area contains all the text of the first page if no summary diagram is in the first page.

### BACKGROUND

1. Technical Field

Embodiments of the present disclosure generally relate to data analysis technology, and more particularly to a computing device and a method for cutting out a summary diagram of a patent document.

2. Description of Related Art

A user may want to search patent documents related to certain conditions. Results of the search may include a list that displays a title and a summary of each patent document. However, it can be difficult understand the characteristics of a patent document from the search result list, so it is difficult to determine all the relevant parts of a patent from the search result list.

### BRIEF DESCRIPTION OF THE DRAWINGS

FIG. 1 is a block diagram of one embodiment of a computing device including a cutting unit for cutting out a summary diagram of a patent document.

FIG. 2A is a schematic diagram of one embodiment of a black-and-white image.

FIG. 2B is a histogram created based on pixel information of each row in a left column of the black-and-white image in FIG. 2A.

FIG. 2C is a histogram based on pixel information of each row in a right column of the black-and-white image in FIG. 2A.

FIG. 2D is a schematic diagram of multiple blocks which are partitioned by blank rows.

FIG. 2E is a schematic diagram of a diagram area in FIG. 2D.

FIG. 3 is a flowchart of one embodiment of a method for cutting out a summary diagram of a patent document.

FIG. 4 is a flowchart detailing step S12 in FIG. 3.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

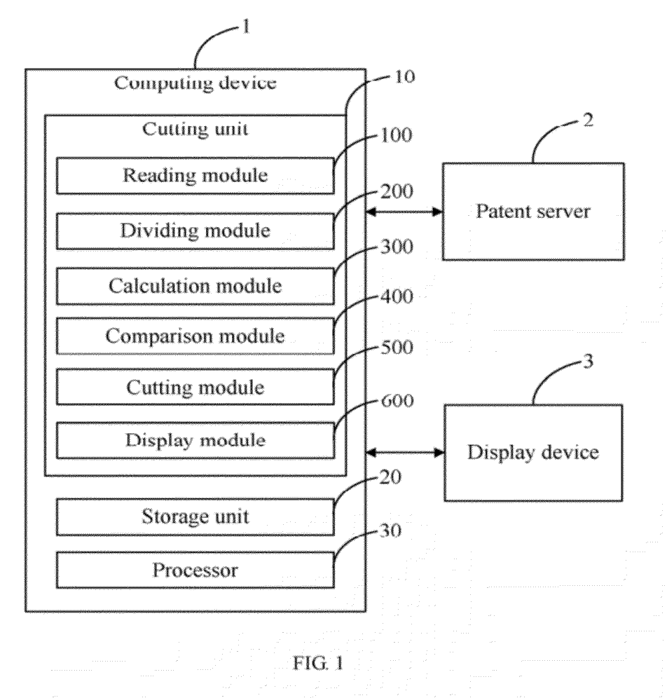

FIG. 1 is a block diagram of one embodiment of a computing device 1. In one embodiment, the computing device 1 includes a cutting unit 10 (for cutting out a summary diagram of a patent document), a storage unit 20, and a processor 30. The computing device 1 electrically connects to a patent server 2 and a display device 3.

The patent server 2 is an electronic system that allows for searching or downloading patent documents from patent databases, such as a Derwent patent database.

The display device 3 displays search results, which are retrieved by the patent server 2 based on conditions input by a user of the computing device 1, and processed by the cutting unit 10.

In one embodiment, the cutting unit 10 may include one or more function modules (a list is given in FIG. 1). The one or more function modules may comprise computerized code in the form of one or more programs that are stored in the storage unit 20, and executed by the processor 30 to provide the functions of the cutting unit 10 described later. The storage unit 20 may be a cache or a dedicated memory, such as an EPROM or flash memory.

In one embodiment, the cutting unit 10 includes a reading module 100, a dividing module 200, a calculation module 300, a comparison module 400, a cutting module 500, and a display module 600.

The reading module 100 is operable to read a first page of a patent document searched through the patent server 2 using Optical Character Recognition (OCR) technology. The first page of the patent document may include a summary diagram. The summary diagram may be one or more figures or charts of the patent document. In one embodiment, the patent document may be in an electronic format, such as WORD, PDF, JPG, or TIF format.

The dividing module 200 is operable to divide the first page into multiple blocks which contain words or the summary diagram. The dividing procedure includes:

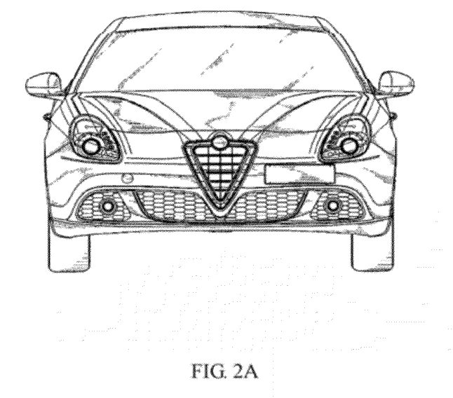

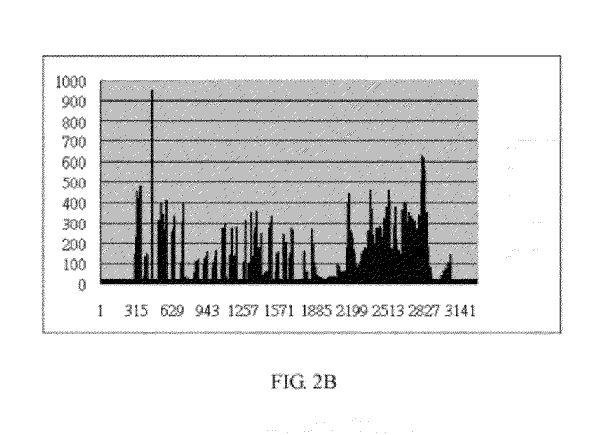

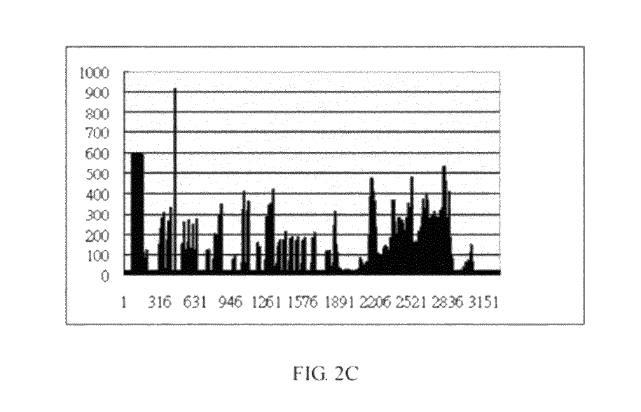

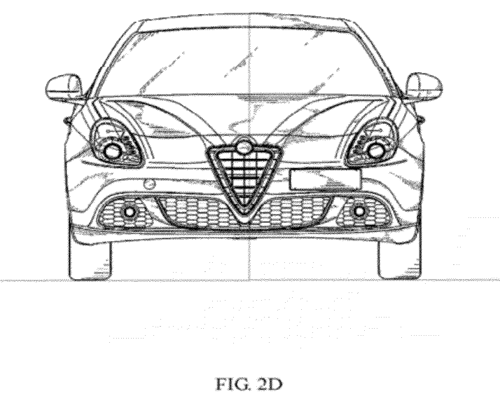

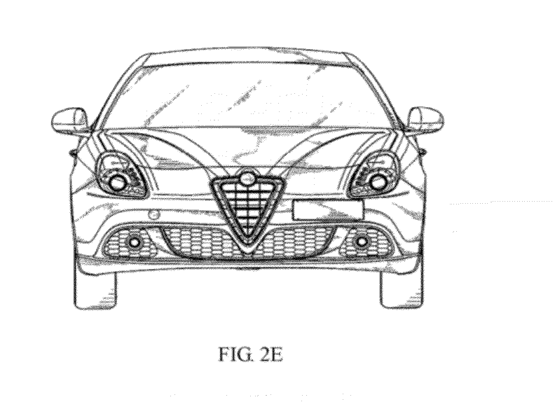

The dividing module 200 converts the first page of the patent document into a black-and-white image based on a predetermined pixel value. The first page of the patent document may be a grayscale image that has 256 different shades of gray, where pixel values can range from 0 to 255. In the first page of the patent document, the areas in which the pixel values are more than the predetermined pixel value are converted into white areas, and the areas in which the pixel values are less than the predetermined pixel value are converted into black areas, where a pixel value of 255 denotes a white area, and a pixel value of 0 denotes a black area (hereinafter, pixels with the value of 255 are regarded as white pixels, and pixels with the value of 0 are regarded as black pixels). FIG. 2A is a schematic diagram of one embodiment of the black-and-white image.

The dividing module 200 creates a histogram based on information as to the black pixels and the white pixels in a left column of the black-and-white image, and a histogram based on information as to the black pixels and the white pixels in a right column of the black-and-white image. It is understood that each page in the great majority of patent documents is divided into the left column and the right column, and both columns include a plurality of rows. FIG. 2B shows a histogram based on pixel information of each row in the left column of the black-and-white image in FIG. 2A, and FIG. 2C shows a histogram based on pixel information of each row in the right column of the black-and-white image in FIG. 2A. In each histogram, the X-axis or horizontal axis represents the height of the rows in the black-and-white image, and the Y-axis or vertical axis represents a number of the black pixels in each row of the black-and-white image.

The dividing module 200 divides the left column and the right column of the black-and-white image into multiple blocks according to information as to the white pixels in the two histograms. The block is an area of the black-and-white image which contains words or the summary diagram. The rows which only have white pixels are regarded as blank rows, and the blank rows divide the black-and-white image into the multiple blocks. FIG. 2D is a schematic diagram of the multiple blocks laid out and partitioned according to the blank rows.

The calculation module 300 is operable to calculate a width value of each of the multiple blocks.

The comparison module 400 is operable to compare the width value of each of the multiple blocks with a predetermined width value, and determine whether there is a block which has a width value greater than the predetermined width value. The determination is used to establish a block that includes the summary diagram. In one embodiment, the predetermined width value is a multiple of five of a width value of each row in the black-and-white image.

The cutting module 500 is operable to select the block which has the width value greater than the predetermined width value, and cut off any area in which the pixel value is 255 (these are blank areas), to maintain a area that includes the summary diagram in the selected block.

The display module 600 is operable to display the area as the diagram in the search result of the patent document on the display device 3. It is understood that if the summary diagram includes more than one figure or chart, there is more than one block which has the width value greater than the predetermined width value. The cutting module 500 selects all of these blocks and cuts off blank areas (in which the pixel' value is 255), to maintain the areas that include the figures or charts, and merges all of the areas into one merged area according to the position of the areas in the first page. Then, the display module 600 displays the merged area as a single diagram in the search result of a patent document on the display device 3. FIG. 2E is a schematic diagram of the diagram area in FIG. 2D. FIG. 2E may be displayed as the diagram in the search result of one patent document, on the display device 3.

The display module 600 is further operable to display a miniature version of the first page of the patent document as the diagram in the search result of the patent document on the display device 3, in response that there is not a block which has the width value greater than the predetermined width value.

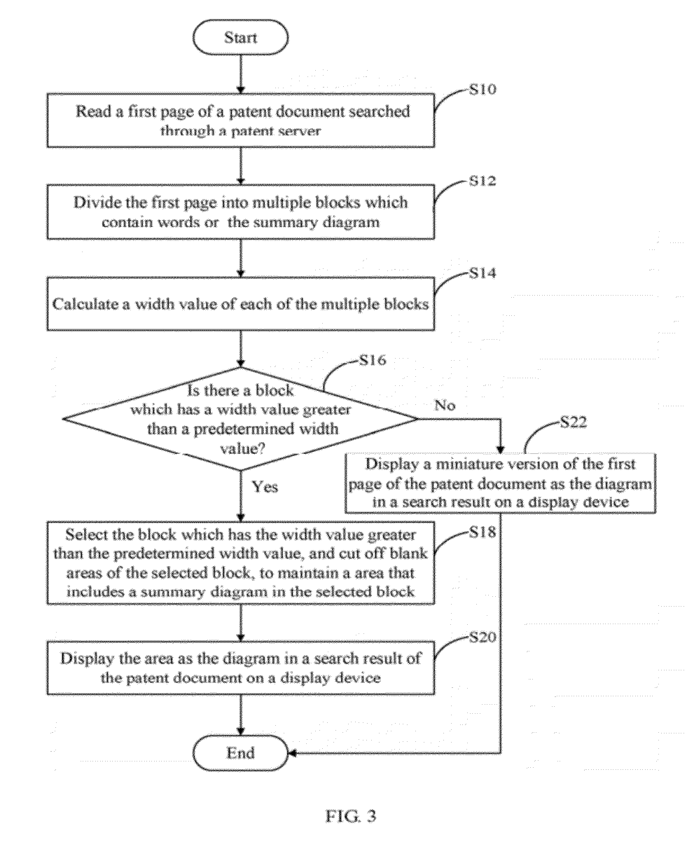

FIG. 3 is a flowchart of one embodiment of a method for cutting out a summary diagram of a patent document. Depending on the embodiment, additional steps may be added, others removed, and the ordering of the steps may be changed.

In step S10, the reading module 100 reads the first page of the patent document searched through the patent server 2 using OCR technology. The first page of the patent document may include a summary diagram. The summary diagram may be one or more figures or charts of the patent document.

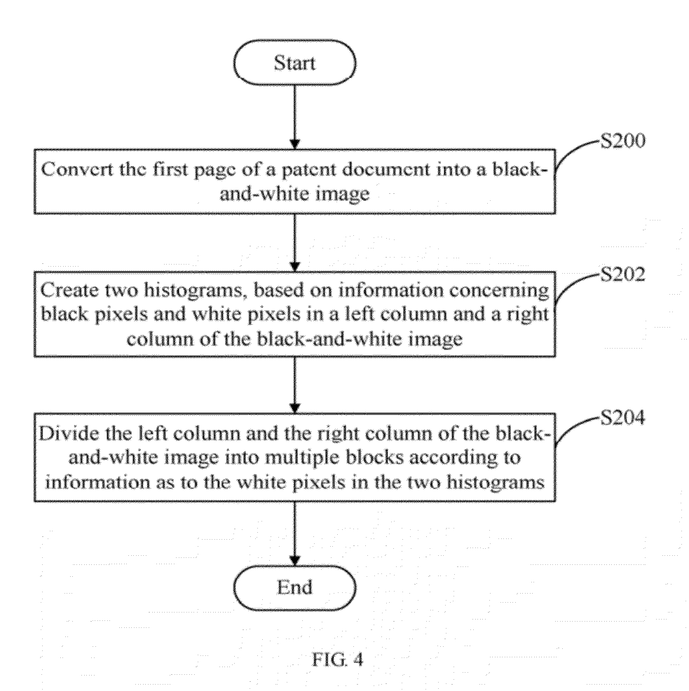

In step S12, the dividing module 200 divides the first page into multiple blocks which contain words or the summary diagram. A description of the dividing procedure is given in FIG. 4.

In step S14, the calculation module 300 calculates a width value of each of the multiple blocks.

In step S16, the comparison module 400 compares the width value of each of the multiple blocks with a predetermined width value, and determines whether there is a block which has a width value greater than the predetermined width value, and this determination is used to establish a block that includes the summary diagram. If there is a block which has the width value greater than the predetermined width value, step S18 is implemented. If there is no block which has the width value greater than the predetermined width value, step S22 is implemented.

In step S18, the cutting module 500 selects the block which has the width value greater than the predetermined width value, and cuts off any area in which the pixel value is 255 (these are blank areas), to maintain a area that includes the summary diagram in the selected block.

In step S20, the display module 600 displays the area as the diagram in the search result of the patent document on the display device 3.

In step S22, the display module 600 displays a miniature version of the first page of the patent document as the diagram in the search result of the patent document on the display device 3.

FIG. 4 is a flowchart detailing the step S12 in FIG. 3.

In step S200, the dividing module 200 converts the first page of the patent document into a black-and-white image based on a predetermined pixel value. The first page of the patent document may be a grayscale image which has 256 different shades of gray, where pixel values can range from 0 to 255. In the first page of the patent document, the areas in which the pixel values are more than the predetermined pixel value are converted into white areas, and the areas in which the pixel values are less than the predetermined pixel value are converted into black areas.

In step S202, the dividing module 200 creates two histograms, based on information concerning the black pixels and the white pixels in a left column of the black-and-white image, and a right column of the black-and-white image. In each histogram, the X-axis represents the height of the rows in the black-and-white image, and the Y-axis represents a number of the black pixels in each row of the black-and-white image.

In step S204, the dividing module 200 divides the left column and the right column of the black-and-white image into multiple blocks according to information as to the white pixels in the two histograms. The rows which only have white pixels are regarded as blank rows, and the blank rows divide the black-and-white image into the multiple blocks.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method being processed by a processor of a computing device, the computing device connected to a display device, the method comprising:
(a) reading a first page of a patent document that is in electronic form;
(b) dividing the first page of the patent document into multiple blocks;
(c) calculating a width value of each of the multiple blocks;
(d) selecting the block which has a width value greater than a predetermined width value, and cutting off blank areas of the selected block, to maintain a area that includes a summary diagram in the selected block; and
(e) displaying the area as the diagram in a search result of the patent document on the display device.

2. The method as claimed in claim 1, wherein the method further comprising:
displaying a miniature version of the first page of the patent document as the diagram in a search result on the display device in response that there is no block which has the width value greater than the predetermined width value.

3. The method as claimed in claim 1, wherein the step (b) further comprising:
converting the first page of the patent document into a black-and-white image;
creating two histograms, based on information concerning the black pixels and the white pixels in a left column of the black-and-white image, and a right column of the black-and-white image; and
dividing the left column and the right column of the black-and-white image into multiple blocks according to information as to the white pixels in the two histograms.

4. The method as claimed in claim 1, wherein the predetermined width value is a multiple of five of a width value of each row in the first page.

5. A non-transitory storage medium storing a set of instructions, the set of instructions capable of being executed by a processor of a computing device to perform a method for cutting a summary diagram of a patent document, the computing device connected to a display device, the method comprising:
(a) reading a first page of a patent document that is in electronic form;
(b) dividing the first page of the patent document into multiple blocks;
(c) calculating a width value of each of the multiple blocks;
(d) selecting the block which has a width value greater than a predetermined width value, and cutting off blank areas of the selected block, to maintain a area that includes a summary diagram in the selected block; and
(e) displaying the area as the diagram in a search result of the patent document on the display device.

6. The non-transitory storage medium as claimed in claim 5, wherein the method further comprising:
displaying a miniature version of the first page of the patent document as the diagram in a search result on the display device in response that there is no block which has the width value greater than the predetermined width value.

7. The non-transitory storage medium as claimed in claim 5, wherein the step (b) further comprising:
converting the first page of the patent document into a black-and-white image;
creating two histograms, based on information concerning the black pixels and the white pixels in a left column of the black-and-white image, and a right column of the black-and-white image; and
dividing the left column and the right column of the black-and-white image into multiple blocks according to information as to the white pixels in the two histograms.

8. The non-transitory storage medium as claimed in claim 5, wherein the predetermined width value is a multiple of five of a width value of each row in the first page.

9. A computing device, the computing device being connected to a display device, the computing device comprising:
a storage unit;
at least one processor; and
one or more programs stored in the storage unit, executable by the at least one processor, the one or more programs comprising:
a reading module operable to read a first page of a patent document that is in electronic form;
a dividing module operable to divide the first page of the patent document into multiple blocks;
a calculation module operable to calculate a width value of each of the multiple blocks;
a cutting module operable to select the block which has a width value greater than the predetermined width value, and cut off blank areas of the selected block, to maintain a area that includes a summary diagram in the selected block; and
a display module operable to display the area as the diagram in a search result of the patent document on the display device.

10. The computing device as claimed in claim 9, wherein the display module is further operable to display a miniature version of the first page of the patent document as the diagram in a search result on the display device in response that there is no block which has the width value greater than the predetermined width value.

11. The computing device as claimed in claim 9, wherein the dividing module is further operable to:
convert the first page of the patent document into a black-and-white image;
create two histograms, based on information concerning the black pixels and the white pixels in a left column of the black-and-white image, and a right column of the black-and-white image; and
divide the left column and the right column of the black-and-white image into multiple blocks according to information as to of the white pixels in the two histograms.

12. The computing device as claimed in claim 9, wherein the predetermined width value is a multiple of five of a width value of each row in the first page.
